(19) United States
(12) Patent Application Publication
(10) Pub. No.: US 2026/0296529 A1
(43) Pub. Date: Oct. 1, 2026

(54) Method for Controlling a Steering Actuator, and Steering System

(71) Applicant: Bayerische Motoren Werke Aktiengesellschaft, Muenchen (DE)

(72) Inventors: Martin MUENSTER, Muenchen (DE); Martin SEDLMAYR, Wessobrunn (DE)

(21) Appl. No.: 18/880,326

(22) PCT Filed: Jun. 28, 2023
(86) PCT No.: PCT/EP2023/067571

§ 371 Date: Dec. 31, 2024

(30) Foreign Application Priority Data
Jul. 29, 2022 (DE) 10 2022 119 064.1

(51) Int. Cl. B62D 5/04

(52) U.S. Cl. CPC B62D 5/0463

(57) ABSTRACT

A method for controlling a steering actuator has the following steps: determining a steering angle change of the at least one wheel; ascertaining a cumulative steering angle change based on the steering angle change, wherein the steering angle change or a weighted steering angle change is summed up quantitatively in order to ascertain the cumulative steering angle change; ascertaining a reduction factor based on the cumulative steering angle change; decreasing a preliminary steering angle target value or a preliminary steering torque target value based on the ascertained reduction factor, thereby obtaining a scaled steering angle target value or a scaled steering torque target value for the steering actuator.

### BACKGROUND AND SUMMARY

The invention relates to a method for controlling a steering actuator. The invention also relates to a steering system.

It has been found that, when there are quick, sustained steering movements at low driving speed or at a standstill, the increased energy demand of an electrically actuated steering of a motor vehicle can lead to undesirably great heating and loading of the on-board electrical system of the vehicle.

The undesirably great heating may lead to accelerated wearing of certain components of the steering, causing additional costs. The loading of the on-board electrical system of the vehicle may lead to lowering of the on-board voltage and consequently impair the functionality of other electrical consumers and actuators.

The object of the invention is therefore to provide a method for controlling a steering actuator and also a steering system which prevents premature wearing of the steering system due to thermal loading and impairments of other electrical consumers and actuators.

The object is achieved according to the invention by a method for controlling a steering actuator. The steering actuator is set up to adjust at least one wheel of a motor vehicle or to assist the adjustment of the at least one wheel by a steering torque. The method comprises the following steps:
determining a change in steering angle of the at least one wheel;
ascertaining a cumulative change in steering angle on the basis of the change in steering angle, wherein the change in steering angle or a weighted change in steering angle is summated in terms of absolute amounts in order to ascertain the cumulative change in steering angle;
ascertaining a reduction factor on the basis of the cumulative change in steering angle;
ascertaining a preliminary steering angle target value or a preliminary steering torque target value for the steering actuator; and
reducing the preliminary steering angle target value or the preliminary steering torque target value on the basis of the reduction factor ascertained, whereby a scaled steering angle target value or a scaled steering torque target value for the steering actuator is obtained.

The method according to the invention is based on the fundamental concept of preemptively preventing thermal overloading of the steering system, in particular of the steering actuator and/or wiring of the steering actuator, and also impairments of other electrical consumers and actuators.

When there are quick and/or sustained steering movements, the value of the cumulative change in steering angle increases. Accordingly, a value of the reduction factor is reduced, whereby the preliminary steering angle target value or the preliminary steering torque target value is reduced more in order to obtain the scaled steering angle target value or the scaled steering torque target value for the steering actuator.

In other words, a steering movement of the at least one wheel or a steering assistance for the at least one wheel of the motor vehicle is therefore preemptively reduced, whereby the thermal loading of the steering system is reduced and premature wearing is prevented. As a result, the functionality of the steering actuator and a sufficient on-board voltage are ensured. Moreover, impairments of other electrical consumers and actuators are reliably prevented.

The method according to the invention in this case manages without additional sensors, since all of the variables used, such as for example the steering angle target value, the steering angle actual value, the vehicle speed and the current degree of electrical utilization, formed from the ratio of the current power consumption to the permissible power consumption, are in any case necessary for controlling the steering actuator and are therefore already available.

The method according to the invention therefore offers a low-cost possible way of preventing premature wearing of the steering system and also impairments of other electrical consumers and actuators.

The at least one wheel is preferably a rear wheel of the motor vehicle. The steering actuator is therefore set up to adjust at least one rear wheel of the motor vehicle, in particular rear wheels of the motor vehicle.

In this case, the preliminary steering angle target value for the steering actuator is ascertained and reduced.

It is, however, also contemplated that the at least one wheel is a front wheel or front wheels of the motor vehicle.

In this case, the preliminary steering torque target value for the steering actuator is ascertained and reduced.

According to one aspect of the invention, the cumulative change in steering angle is reduced on the basis of a decay constant. In other words, the value of the cumulative change in steering angle is reduced again over time, so that the value of the reduction factor increases again. If therefore over a certain time there is no longer any quick steering movement and/or no longer any sustained steering movement, the steering angle target value or the steering torque target value is reduced less or, as from a certain point in time, is no longer reduced.

In a refinement of the invention, the reduction factor is ascertained from the cumulative change in steering angle on the basis of a predefined characteristic curve. The predefined characteristic curve may for example be prescribed by the manufacturer of the steering system or of the motor vehicle. The predefined characteristic curve accordingly allows desired handling characteristics of the motor vehicle to be set. As an alternative or in addition, with the predefined characteristic curve, material properties of the steering system, in particular of the steering actuator and/or wiring of the steering actuator, can be taken into account, so that the steering system or the steering actuator is not thermally overloaded.

The change in steering angle is preferably weighted on the basis of a speed-dependent characteristic curve in order to ascertain the cumulative change in steering angle. To be more precise, the characteristic curve depends on a speed of the motor vehicle. The speed-dependent characteristic curve maps the thermal input due to the changes in steering angle in dependence on the speed of the motor vehicle.

In particular, the cumulative change in steering angle is weighted more at low speed than at high speed.

According to a further aspect of the invention, the change in steering angle is weighted on the basis of a degree of electromechanical utilization of the steering actuator in order to ascertain the cumulative change in steering angle. The degree of electromechanical utilization maps the thermal input due to the changes in steering angle in dependence on the loading state of the steering actuator.

The degree of electromechanical utilization may for example be formed from the ratio of the current power consumption to the permissible power consumption, so that the cumulative change in steering angle can be weighted more when there is a high degree of utilization than when there is a lower degree of utilization.

The change in steering angle could be weighted on the basis of an actual steering angle of the at least one wheel, for example on the basis of a steering-angle-dependent characteristic curve. This maps the thermal input due to the changes in steering angle in dependence on the actual steering angle.

The individual influencing variables, in particular the speed of the motor vehicle, the degree of electromechanical utilization and/or the actual steering angle, can therefore be mapped (individually) by way of characteristic curves.

It is, however, also contemplated to map two or more or all of these influencing variables combined in at least one family of characteristic curves, in particular also in a number of families of characteristic curves.

In particular, the change in steering angle is only summated if an absolute amount of the change in steering angle is greater than a predefined limit value. If the absolute amount of the change in steering angle is therefore less than the predefined limit value, the value of the cumulative change in steering angle is not increased. Therefore, an adjustable “dead zone” around a change in steering angle of 0 is provided.

A predefined minimum value for the reduction factor may be provided. This ensures that the scaled steering angle target value or the scaled steering torque target value for the steering actuator is not reduced to zero, which would have the consequence that a steering movement or a steering assistance does not take place. Instead, the steering movement or the steering assistance is at most reduced to a limit value prescribed by the predefined minimum value.

The reduction factor is preferably only updated when the steering angle passes through zero. Updating of the reduction factor therefore does not take place during cornering, but only between two different curves or between two turns of the steering wheel in different directions. This does not cause any change in the steering performance of the motor vehicle during cornering.

In a further refinement of the invention, the preliminary steering angle target value or the preliminary steering torque target value is only reduced below a predefined limit speed of the motor vehicle. It has been found that the thermal loading in typical operating states of the motor vehicle above a certain limit speed is so small that a reduction of the preliminary steering angle target value or the preliminary steering torque target value is not necessary, since less force is necessary to adjust the wheels.

In particular, the method described above therefore takes place when the motor vehicle is at a standstill or at speeds of the motor vehicle up to the predefined limit speed both when driving forward and when reversing.

The object is also achieved according to the invention by a steering system with at least one electromechanical steering actuator and a control unit for the steering actuator. The steering system is set up to perform a method described above.

With regard to the advantages and further properties of the steering system, reference is made to the above explanations with regard to the method, which apply equally to the steering system, and vice versa.

Further advantages and properties of the invention will become apparent from the following description and the drawing, to which reference is made.

### BRIEF DESCRIPTION OF THE DRAWING

The single drawing is a block diagram of a control circuit for carrying out a method for controlling a steering actuator according to an embodiment of the invention.

### DETAILED DESCRIPTION OF THE DRAWING

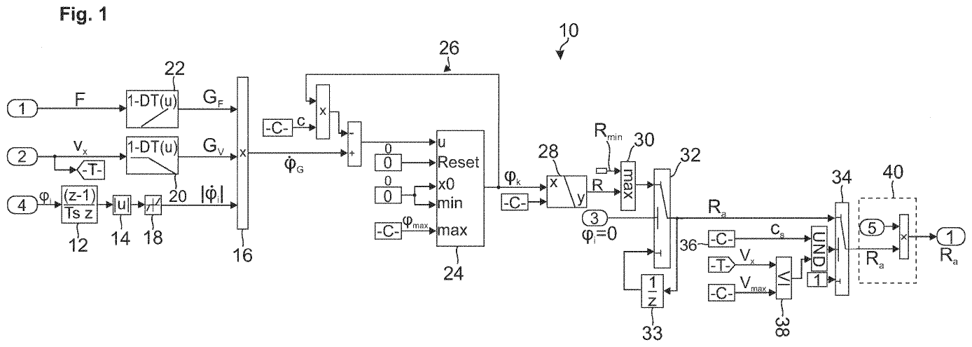

FIG. 1 schematically shows a block diagram of a control circuit 10, which is implemented in a control unit for a steering actuator of a motor vehicle.

To be more precise, FIG. 1 shows a detail from a complete control circuit for the steering actuator of the motor vehicle.

The steering actuator is an electromechanical actuator which is set up to adjust at least one wheel of the motor vehicle or to assist the adjustment of the at least one wheel by a steering torque.

The at least one wheel is preferably a rear wheel of the motor vehicle. The steering actuator is therefore set up to adjust at least one rear wheel of the motor vehicle, in particular rear wheels of the motor vehicle.

It is, however, also contemplated that the at least one wheel is a front wheel or front wheels of the motor vehicle. In this case, the steering actuator is set up to assist the adjustment of the at least one wheel by the steering torque.

Unless otherwise mentioned, the following explanations apply to both cases, that is to say to rear wheels and front wheels.

A steering system of the motor vehicle, in particular the control unit, is set up to carry out a method for controlling the steering actuator which is described below on the basis of the control circuit 10 shown in FIG. 1.

An actual steering angle φi of the at least one wheel is obtained and differentiated by time by means of a differentiator 12, whereby a change in steering angle is obtained.

In an absolute amount block 14, the absolute amount of the change in steering angle |φ^{⋅}| is determined and is fed to a multiplication block 16.

Optionally, the absolute amount of the change in steering angle |φ^{⋅}| may be weighted with a predefined characteristic curve 18, in particular wherein the predefined characteristic curve 18 has a dead band around 0.

The value of the absolute amount of the change in steering angle |φ¹⁰⁸ | which is fed to the multiplication block 16 is therefore only different from 0 if the absolute amount of the change in steering angle |φ^{⋅}| is greater than a predefined limit value.

Furthermore, the absolute amount of a speed vx of the motor vehicle is obtained, in particular wherein it is the absolute amount of a longitudinal velocity of the motor vehicle or the absolute amount of a centroid velocity of the motor vehicle.

On the basis of the absolute amount obtained for the speed vx of the motor vehicle, a speed-dependent weighting factor Gv is ascertained from a speed-dependent characteristic curve 20 and is fed to the multiplication block 16.

In this case, a weighting factor Gv for smaller values of the speed vx is greater than or equal to a weighting factor Gv for greater values of the speed vx.

The weighting factor Gv is therefore a monotonically decreasing function of the absolute amount of the speed vx.

Furthermore, a degree of electromechanical utilization F of the steering actuator is obtained, in particular wherein the degree of electromechanical utilization F is provided by the steering actuator itself.

The degree of electromechanical utilization F may in this case assume values between 0% (no utilization) and 100% (full utilization).

On the basis of a predefined characteristic curve 22, a weighting factor GF is obtained from the degree of utilization F obtained and is fed to the multiplication block 16.

In this case, the weighting factor GF for smaller values of the degree of utilization F is less than for greater values of the degree of utilization F.

Furthermore, on the basis of the actual steering angle φi of the at least one wheel, a weighting factor Gφ could be ascertained and fed to the multiplication block 16.

In particular, the weighting factor Gφ is ascertained on the basis of a predefined steering-angle-dependent characteristic curve.

The multiplication block 16 forms from the absolute amount of the change in steering angle |φ^{⋅}| and from the weighting factors GV, GF, Gφ a weighted change in steering angle φ^{⋅}G, which is fed to an integrator 24.

The individual influencing variables, in particular the speed vx of the motor vehicle, the degree of electromechanical utilization F and/or the actual steering angle φi, can therefore be mapped (individually) by way of characteristic curves.

It is, however, also contemplated to map two or more or all of these influencing variables combined in families of characteristic curves in a mechanical actuator model.

The integrator 24 integrates the weighted change in steering angle φ^{⋅}G over time, whereby a cumulative change in steering angle φk is obtained.

Optionally, an upper limit φmax for the value of the cumulative change in steering angle may be provided. The output value of the integrator 24, that is to say the cumulative change in steering angle φk, then cannot exceed this upper limit φmax.

Also provided is a feedback loop 26, in which the cumulative change in steering angle φk is multiplied by a decay constant c and subtracted from the weighted change in steering angle φ^{⋅}G.

The feedback loop 26 achieves the effect that the value of the cumulative change in steering angle φk is reduced over time on the basis of the decay constant c.

From the cumulative change in steering angle, a reduction factor R is ascertained on the basis of a predefined characteristic curve 28.

The value of the reduction factor R is between 0 and 1, wherein a smaller value of the reduction factor R in the case of a rear wheel means that a steering angle target value for the steering actuator is reduced more, and in the case of a front wheel means that a steering torque target value for the steering actuator is reduced more, as explained in still more detail below.

The predefined characteristic curve 28 may for example be prescribed by the manufacturer of the steering system or of the motor vehicle and thus be adapted to different circumstances of the respective vehicle.

The predefined characteristic curve 28 for example allows desired handling characteristics of the motor vehicle to be set.

As an alternative or in addition, with the predefined characteristic curve, material properties of the steering system, in particular of the steering actuator and/or wiring of the steering actuator, and also geometrical installation conditions can be taken into account.

A predefined minimum value Rmin for the reduction factor is provided. A comparator 30 compares the reduction factor R with the minimum value Rmin and outputs the greater of the two values to an update block 32.

The update block 32 only updates the value output for the reduction factor Ra when the actual steering angle passes through zero, that is to say only when there is a change in sign of φi.

If the actual steering angle φi has not passed through zero, the previous value of the reduction factor Ra output is output once again by way of a delay element 33.

The reduction factor Ra output by the update block 32 is fed to an output block 34.

The output block 34 only outputs the reduction factor Ra when two conditions are satisfied.

On the one hand, the reduction functionality must be switched on, i.e. a parameter cS obtained from a switch block 36 must indicate that the reduction functionality has been switched on.

On the other hand, the absolute amount of the speed vx of the motor vehicle must be less than a predefined limit speed vmax of the motor vehicle.

For this purpose, a comparator 38 compares the speed vx of the motor vehicle with the predefined limit speed vmax of the motor vehicle and outputs the result of the comparison to the output block 34.

Optionally, a smoothing block 40, which is set up to smooth the reduction factor Ra output, may also be provided downstream of the output block 34.

In particular, the smoothing block 40 smooths jumps in the reduction factor Ra output, and consequently in the scaled steering angle target value or scaled steering torque target value described below.

In the case of a rear wheel, a preliminary steering angle target value, which is ascertained by a control circuit for the steering actuator, is reduced on the basis of the reduction factor Ra output, whereby a scaled steering angle target value for the steering actuator is obtained.

In particular, the scaled steering angle target value Δφtarget is ascertained from the preliminary steering angle target value Δφ by multiplying by the reduction factor Ra output, that is to say according to Δφtarget=Ra·Δφ.

In the case of a front wheel, a preliminary steering torque target value, which is ascertained by a control circuit for the steering actuator, is reduced on the basis of the reduction factor Ra output, whereby a scaled steering torque target value for the steering actuator is obtained.

In particular, the scaled steering torque target value Ttarget is ascertained from the preliminary steering torque target value T by multiplying by the reduction factor Ra output, that is to say according to Ttarget=Ra·T. The method described above therefore preemptively reduces a steering movement of the at least one wheel of the motor vehicle or a steering assistance provided, whereby the thermal loading of the steering system is reduced and premature wearing is prevented. Furthermore, impairments of other electrical consumers and actuators are prevented.

1-10. (canceled)

11. A method for controlling a steering actuator, wherein the steering actuator is set up to adjust at least one wheel of a motor vehicle or to assist adjustment of the at least one wheel by a steering torque, the method comprising the steps of:
determining a change in steering angle (φ^{⋅}i) of the at least one wheel;
ascertaining a cumulative change in steering angle (φk) on the basis of the change in steering angle (φ^{⋅}i), wherein the change in steering angle (φ^{⋅}i) or a weighted change in steering angle (φ^{⋅}G) is summated in terms of absolute amounts in order to ascertain the cumulative change in steering angle (φk);
ascertaining a reduction factor (Ra) on the basis of the cumulative change in steering angle (φk);
ascertaining a preliminary steering angle target value or a preliminary steering torque target value for the steering actuator; and
reducing the preliminary steering angle target value or the preliminary steering torque target value on the basis of the reduction factor (Ra) ascertained, whereby a scaled steering angle target value or a scaled steering torque target value for the steering actuator is obtained.

12. The method according to claim 11, wherein the cumulative change in steering angle (φk) is reduced on the basis of a decay constant (c).

13. The method according to claim 11, wherein
the reduction factor (Ra) is ascertained on the basis of a predefined characteristic curve from the cumulative change in steering angle (φk).

14. The method according to claim 11, wherein
the change in steering angle (φ^{⋅}i) is weighted on the basis of a speed-dependent characteristic curve in order to ascertain the cumulative change in steering angle (φk).

15. The method according to claim 11, wherein
the change in steering angle (φ^{⋅}i) is weighted on the basis of a degree of electromechanical utilization (F) of the steering actuator in order to ascertain the cumulative change in steering angle (φk).

16. The method according to claim 11, wherein
the change in steering angle (φ^{⋅}i) is only summated when an absolute amount of the change in steering angle (|φ^{⋅}i|) is greater than a predefined limit value.

17. The method according to claim 11, wherein a predefined minimum value (Rmin) for the reduction factor (Ra) is provided.

18. The method according to claim 11, wherein the reduction factor (Ra) is only updated when the steering angle (φi) passes through zero.

19. The method according to claim 11, wherein
the preliminary steering angle target value or the preliminary steering torque target value is only reduced below a predefined limit speed (vmax) of the motor vehicle.

20. A steering system, comprising:
at least one electromechanical steering actuator; and
a control unit for the steering actuator, wherein the control unit is configured to:
determine a change in steering angle (φ^{⋅}i) of the at least one wheel;
ascertain a cumulative change in steering angle (φk) on the basis of the change in steering angle (φ^{⋅}i), wherein the change in steering angle (φ^{⋅}i) or a weighted change in steering angle (φ^{⋅}G) is summated in terms of absolute amounts in order to ascertain the cumulative change in steering angle (φk);
ascertain a reduction factor (Ra) on the basis of the cumulative change in steering angle (φk);
ascertain a preliminary steering angle target value or a preliminary steering torque target value for the steering actuator; and
reduce the preliminary steering angle target value or the preliminary steering torque target value on the basis of the reduction factor (Ra) ascertained, whereby a scaled steering angle target value or a scaled steering torque target value for the steering actuator is obtained.
